(19) United States
(12) Patent Application Publication
(10) Pub. No.: US 2026/0073701 A1
(43) Pub. Date: Mar. 12, 2026

(54) CONSISTENCY-BASED PERTURBATION DETECTION FOR PERCEPTION SYSTEMS

(71) Applicant: QUALCOMM Incorporated, San Diego, CA (US)

(72) Inventors: Cong CHEN, San Diego, CA (US); Jonathan PETIT, Wenham, MA (US); Jean-Philippe MONTEUUIS, Northborough, MA (US); Marvin Richard KLINGNER, Braunschweig (DE)

(21) Appl. No.: 18/830,392

(22) Filed: Sep. 10, 2024

(51) Int. Cl. G06V 20/56

(52) U.S. Cl. CPC G06V 20/56

(57) ABSTRACT

Systems and techniques are described herein for perturbation detection. For example, a computing device can produce, using a first model based on input data, first output data. The computing device can produce, using a second model based on the input data, second output data. The computing device can determine, based on the first output data and the second output data, a consistency score indicating a consistency between the first output data and the second output data. The computing device can determine, based on the consistency score being less than a consistency score threshold, the input data comprises a perturbation.

### FIELD

The present disclosure generally relates to perturbation detection. For example, aspects of the present disclosure relate to consistency-based perturbation detection for perception systems.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle. Sensor data, such as images captured from one or more cameras, may be gathered, transformed, and analyzed to detect objects. Attackers can induce perturbations in the sensor data which can cause a perception system in a vehicle to inaccurately detect objects. Detecting the existence of perturbations in the sensor data is important to ensure sensor data integrity for an accurate detection of objects.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for consistency-based perturbation detection for perception systems. In some aspects, an apparatus for perturbation detection is provided. The apparatus includes at least one memory and at least one processor coupled to the at least one memory and configured to: producing, using a first model based on input data, first output data; producing, using a second model based on the input data, second output data; determining, based on the first output data and the second output data, a consistency score indicating a consistency between the first output data and the second output data; and determining, based on the consistency score being less than a consistency score threshold, the input data includes a perturbation.

In some aspects, a method for perturbation detection at a device is provided. The method includes: producing, by a first model based on input data, first output data; producing, by a second model based on the input data, second output data; determining, based on the first output data and the second output data, a consistency score indicating a consistency between the first output data and the second output data; and determining, based on the consistency score being less than a consistency score threshold, the input data includes a perturbation.

In some aspects, a non-transitory computer-readable medium is provided having stored thereon instructions that, when executed by at least one processor, cause the at least one processor to: produce, using a first model based on input data, first output data; producing, using a second model based on the input data, second output data; determine, based on the first output data and the second output data, a consistency score indicating a consistency between the first output data and the second output data; and determine, based on the consistency score being less than a consistency score threshold, the input data includes a perturbation.

In some aspects, an apparatus for perturbation detection is provided. The apparatus includes: means for producing, based on input data, first output data; means for producing, based on the input data, second output data; means for determining, based on the first output data and the second output data, a consistency score indicating a consistency between the first output data and the second output data; and means for determining, based on the consistency score being less than a consistency score threshold, the input data includes a perturbation.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIGS. 1A and 1B are block diagrams illustrating a vehicle suitable for implementing various techniques described herein, in accordance with aspects of the present disclosure.

FIG. 1C is a block diagram illustrating components of a vehicle suitable for implementing various techniques described herein, in accordance with aspects of the present disclosure.

FIG. 1D illustrates an example implementation of a system-on-a-chip (SOC), in accordance with some examples.

FIG. 2 is a block diagram illustrating an example architecture of an image capture and processing system, in accordance with some examples.

FIG. 3 is a block diagram illustrating an example of interactions between components of an image capture and processing system, in accordance with some examples.

FIG. 4 is a diagram illustrating an example of an image including perturbations, in accordance with some examples.

FIG. 5 is a diagram illustrating an example of a process for consistency-based perturbation detection, in accordance with some examples.

FIG. 6 is a diagram illustrating an example of an intersection and union of two bounding boxes, in accordance with some examples.

FIG. 7 is a diagram illustrating an example of a process for consistency-based perturbation detection, where the system employs an object detection model and an instance segmentation model, in accordance with some examples.

FIG. 8 is a diagram illustrating different examples of input data, in accordance with some examples.

FIG. 9 is a diagram illustrating an example of a process for determining a consistency score between two sets of output data, in accordance with some examples.

FIG. 10 is a diagram illustrating an example of a process for determining a consistency score threshold, in accordance with some examples.

FIG. 11 is a diagram illustrating an example of a process for selecting a pair of models to employ for consistency-based perturbation detection, in accordance with some examples.

FIG. 12 is a diagram illustrating an example of determining regions of perturbations within input data based on densities of bounding boxes, in accordance with some examples.

FIG. 13 is a flow diagram illustrating an example of a process for perturbation detection, in accordance with some aspects of the disclosure.

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, increasingly, systems and devices (e.g., autonomous vehicles, such as autonomous and semi-autonomous cars, drones, mobile robots, mobile devices, XR devices, and other suitable systems or devices) include multiple sensors (e.g., camera sensors, radar sensors, and/or light detection and ranging (LIDAR) sensors) to gather information about the environment, as well as processing systems to process the information gathered, such as for route planning, navigation, collision avoidance, etc. One example of such a system is an ADAS for a vehicle. Sensor data, such as images captured from one or more cameras, may be gathered, transformed, and analyzed to detect objects.

Attackers may induce perturbations, which may be referred to as adversarial examples (AEs), in the sensor data (e.g., image sensor data in the form of images). As used herein, a perturbation to sensor data is any modification of the sensor data that may cause a perception system (e.g., within a vehicle) to inaccurately detect objects using the sensor data. An example of a perturbation is modifying (or perturbing) pixels of an image to include a false object in an image that is not actually in a scene depicted in the image (e.g., adding a false or fake stop sign in an image to cause a perception system of a vehicle to detect the stop sign and perform a corresponding function, such as perform automatic breaking). In some cases, an attacker can optimize the perturbations added to the sensor data to deceive the perception system, while still remaining imperceptible to humans. These perturbations can potentially lead to safety issues, for example when the perception system is employed for autonomous driving and/or health care use cases. Therefore, determining the existence of perturbations in the sensor data is important to ensure sensor data integrity for an accurate object detection.

As such, improved systems and techniques for detecting perturbations in sensor data can be beneficial.

In one or more aspects of the present disclosure, systems, apparatuses, methods (also referred to as processes), and computer-readable media (collectively referred to herein as “systems and techniques”) are described herein that provide solutions for consistency-based perturbation detection for perception systems.

Various aspects relate generally to perturbation detection. Some aspects more specifically relate to systems and techniques that provide solutions for detecting perturbations in sensor data, which may include image sensor (e.g., camera) data, radar sensor data, and/or light detection and ranging (LIDAR) sensor data. In one or more examples, the solutions allow for an adaptive input selection (e.g., which may be based on a region or an object class), an optimal perception model search (e.g., determining a model set, or vision task set, that produces outputs that allow for an optimal perturbation detection), a consistency score-based perturbation detection (e.g., which includes a method for determining a threshold to use for comparing the consistency score to determine perturbation), and localization of the detected perturbation within the sensor data. In some aspects, perception model can be a machine learning model (e.g., a neural network model) used to detect perturbations (e.g., perturbations in images).

In one or more examples, the systems and techniques employ a consistency technique to detect the existence of perturbations within sensor data. In some examples, the systems and techniques can determine the location of perturbed pixels within sensor data in the form of an image. The systems and techniques can select regions of interest (e.g., within the image) to detect perturbations. The selection of the regions of interest can be adaptive, which may be based on a region class or an object class. The systems and techniques can select an optimum model pair (e.g., including an object detection model and a segmentation model) that yields outputs that provide a highest consistency between clean images to reduce any false positives. The systems and techniques can perform consistency checks offline on each model pair to determine the model pair with the highest average consistency score. In one or more examples, the systems and techniques can, based on the density of false bounding boxes due to perturbations, determine the affected (e.g., perturbed) pixels. In one or more examples, when the model pair includes an object detection model and a segmentation model, the systems and techniques can calculate a consistency score to capture how many detected bounding boxes have matching segmentation masks based on an intersection over union (IoU). In some examples, an IoU threshold can be determined through an offline calculation of consistency scores of a clean data set, based on a false positive rate requirement.

In one or more aspects, during operation for perturbation detection, a first model, based on input data, can produce first output data. A second model, based on the input data, can produce second output data. One or more processors can determine, based on the first output data and the second output data, a consistency score indicating a consistency between the first output data and the second output data. The one or more processors can determine, based on the consistency score being less than a consistency score threshold, the input data comprises one or more perturbations.

In one or more examples, the one or more processors can select the input data from sensor data, where the input data is a portion of the sensor data. In some examples, selecting the input data from the sensor data can be based on one or more objects detected within the portion of the sensor data, a use case associated with the sensor data, a time of day the sensor data was obtained, a day the sensor data was obtained, a location associated with the sensor data, and/or a traffic scenario associated with the sensor data. In one or more examples, the sensor data may be image sensor data, radar sensor data, or light detection and ranging (LIDAR) sensor data. In some examples, determining the consistency score can be based on determining an intersection over union (IoU) of a pairwise comparison between the first output data and the second output data, and determining the IoU is greater than an IoU threshold value.

In one or more examples, the one or more processors can determine a region within the input data for each perturbation of the one or more perturbations based on a density of bounding boxes, from at least one of the first output data or the second output data, located at the region. In some examples, the one or more processors can choose the first model and the second model to use as a pair of models based on determining another consistency score by the first model and the second model based on clean input data without perturbations, where the other consistency score is greater than consistency scores produced by other pairs of models based on the clean input data. As noted above, clean input data is input data (e.g., from one or more sensors, such as a camera, LIDAR sensor, radar sensor, etc.) that does not have perturbations. For example, a clean image can be an image that does not have altered pixels with perturbations (e.g., with a false object inserted into the image).

In some examples, the first model and the second model can each be an object detection model, an instance segmentation model, a depth estimation model, or a traffic sign recognition model. In some aspects, the models can be machine learning models (e.g., neural network models). For instance, the object detection model can be a Faster R-CNN model, a you only look once (YOLO) model, a single-stage object detection (SSD) model, or a RetinaNet model. In some examples, the instance segmentation model can be a Mask R-CNN model, a Mask2Former model, a you only look once (YOLO) segmentation (Seg) model, or a successive approximation model (SAM).

Particular aspects of the subject matter described in this disclosure can be implemented to realize one or more of the following potential advantages. In one or more examples, the systems and techniques can provide the benefit of providing an effective and accurate measurement of the consistency between different vision tasks or models. In some examples, the systems and techniques can provide the benefit of locating perturbed pixels in image sensor data, which can allow for potentially fixing the perturbations within the data. In one or more examples, the systems and techniques can provide the benefit of reducing false positive and false negative results from object detection solutions, which can lead to the reduction of computational overhead.

Additional aspects of the present disclosure are described in more detail below.

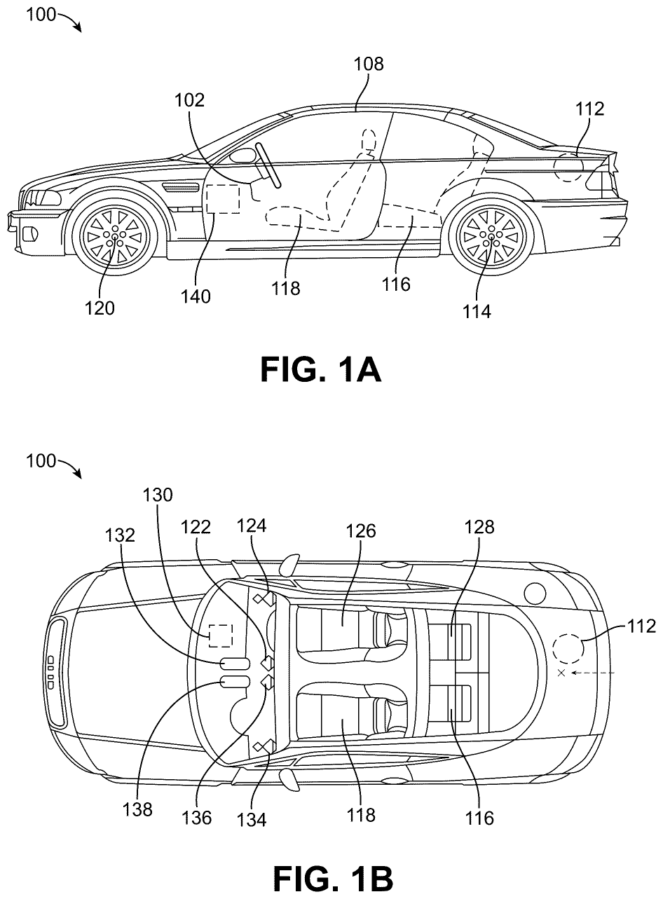

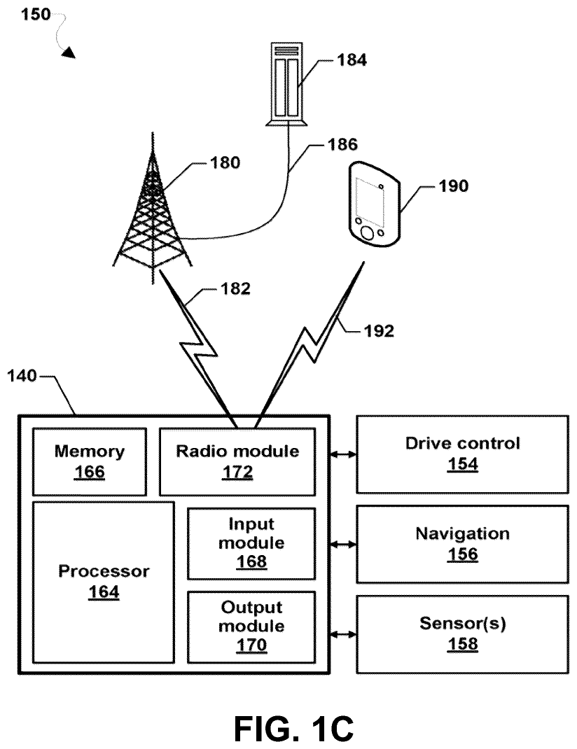

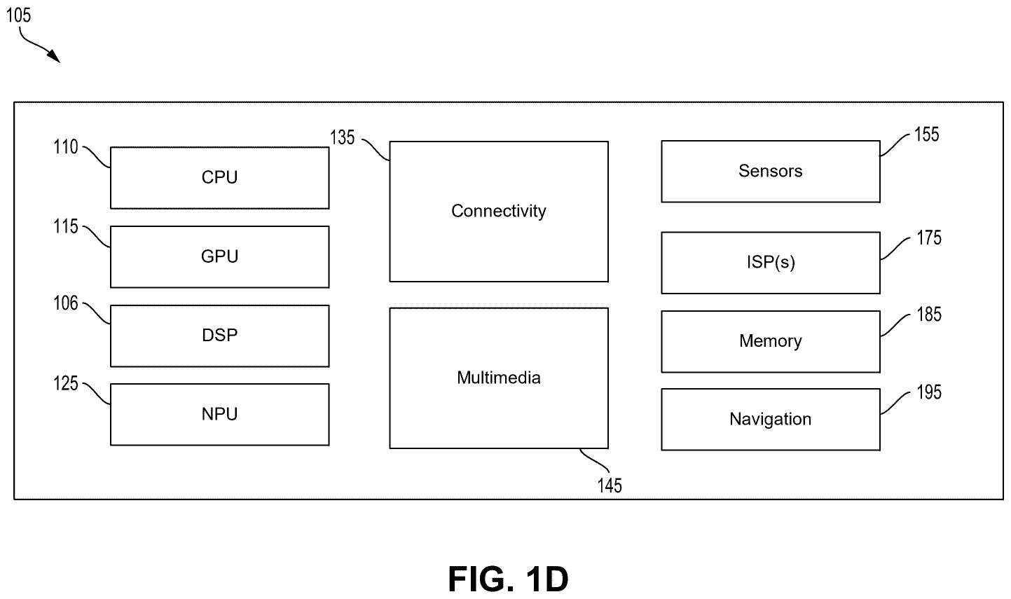

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136, radar 132, and LIDAR 138. In some embodiments, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some embodiments, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described, and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

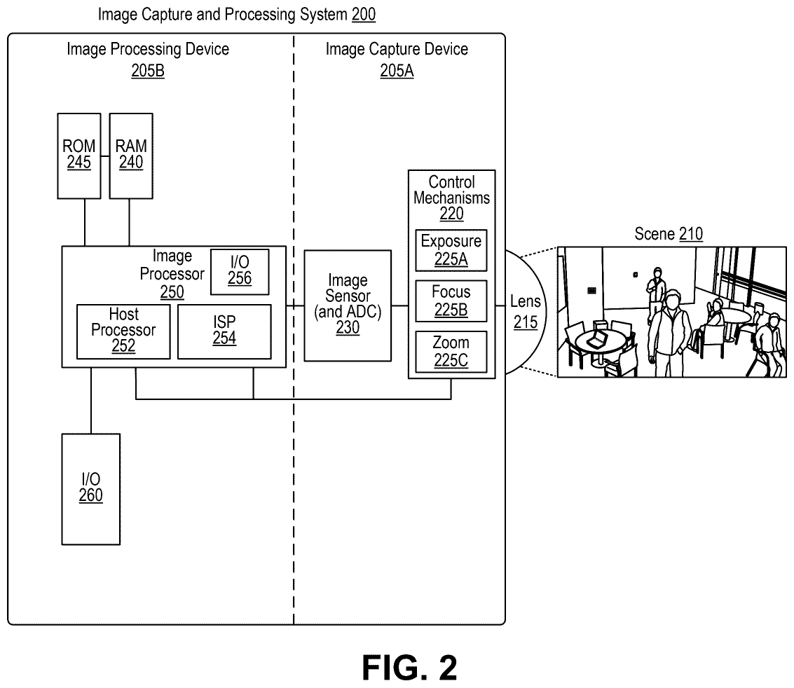

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. A lens 215 of the system 200 faces a scene 210 and receives light from the scene 210. The lens 215 bends the light toward the image sensor 230. The light received by the lens 215 passes through an aperture controlled by one or more control mechanisms 220 and is received by an image sensor 230.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo, thereby adjusting focus. In some cases, additional lenses may be included in the system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), or some combination thereof. The focus setting may be determined using the control mechanism 220, the image sensor 230, and/or the image processor 250. The focus setting may be referred to as an image capture setting and/or an image processing setting.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 225C moves one or more of the lenses in the afocal zoom system, such as the negative lens and one or both of the positive lenses.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 230 may alternately or additionally include opaque and/or reflective masks that block light from reaching certain photodiodes, or portions of certain photodiodes, at certain times and/or from certain angles, which may be used for phase detection autofocus (PDAF). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 250 may include one or more processors, such as one or more image signal processors (ISPs) (including ISP 254), one or more host processors (including host processor 252), and/or one or more of any other type of processor 1410 discussed with respect to the computing system 1400. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240/1425, read-only memory (ROM) 245/1420, a cache 1412, a memory unit (e.g., system memory 1415), another storage device 1430, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1435, any other input devices 1445, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the system 200 and one or more peripheral devices, over which the system 200 may receive data from the one or more peripheral device and/or transmit data to the one or more peripheral devices. The I/O 260 may include one or more wireless transceivers that enable a wireless connection between the system 200 and one or more peripheral devices, over which the system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

The host processor 252 can configure the image sensor 230 with new parameter settings (e.g., via an external control interface such as I2C, I3C, SPI, GPIO, and/or other interface). In one illustrative example, the host processor 252 can update exposure settings used by the image sensor 230 based on internal processing results of an exposure control algorithm from past image frames. The host processor 252 can also dynamically configure the parameter settings of the internal pipelines or modules of the ISP 254 to match the settings of one or more input image frames from the image sensor 230 so that the image data is correctly processed by the ISP 254. Processing (or pipeline) blocks or modules of the ISP 254 can include modules for lens (or sensor) noise correction, de-mosaicing, color conversion, correction or enhancement/suppression of image attributes, denoising filters, sharpening filters, among others. Each module of the ISP 254 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image sensor 230 can support dynamic switching between different operational modes that the image sensor 230 supports. Examples of the different operation modes include power off mode, software standby mode, stream on and off mode, among others. For instance, in stream operation mode, the image sensor is fully powered. With the stream operation on, the image sensor starts streaming image data (e.g., on the CSI-2 PHY layer port or interface). With the stream operation off, the image sensor stops streaming image data. In some cases, the host processor 252 can perform a dynamic parameter reconfiguration process that allows the image sensor 230 to support dynamic switching between the different operational modes without going through stream on and off and/or software standby procedures. Dynamic parameter reconfiguration refers to a process performed by the host processor 252 (e.g., an AP or other processor) to configure and update sensor internal register settings on-the-fly (e.g., as the operational modes change) without powering off the image sensor 230 and then powering on or putting the image sensor 230 into a software standby mode. Software standby mode refers to an operational mode of the image sensor 230 where the image sensor 230 is powered on and the camera control interface (CCI) communication is operational, but the image sensor 230 cannot capture and stream image data (e.g., on the CSI bus).

Such dynamic switching can reduce latency of mode switching processing and can improve user experience. Examples of the image sensor 230 dynamically switching between different operational modes include switching between turning high dynamic range (HDR) on and off, switching between a different number of exposures, switching between turning binning on and off (e.g., generating a 12 megapixel (MP) image using a 2×2 Quad Color Filter Array (QCFA) when binning is on and generating a 48 MP image by remosaicing the QCFA to a Bayer color filter array (CFA) when binning is off), among others.

Switching between operational modes (referred to as mode-switching scenarios) is different than changing image capture settings (referred to as non-mode-switching scenarios). For example, modifying image capture settings (e.g., exposure, focus, etc.) can result in a modification of how an image is captured and/or processed by the image sensor 230 and/or the ISP 254 (e.g., resulting in a brighter image, an image with a particular object in focus, etc.). However, if a setting of the image sensor 230 is incorrect or the image sensor 230 and/or ISP 254 are late in applying a setting in a non-mode-switching scenario, the result will be that a captured image is captured and/or processed with slight loss of quality in the processed image (e.g., without the intended settings, such as the image being slightly darker than intended, with an object slightly more out of focus than intended, etc.). However, when switching between operational modes in a mode-switching scenario (e.g., from HDR off to HDR on), applying the incorrect settings can result in a system failure, such as system hang or freeze, which can require a hardware reset of the ISP 254 and/or other components of the image capture and processing system 200. For instance, if the ISP 254 is unaware of the correct settings of an image frame produced by the image sensor 230 and mistakenly applies erroneous settings or parameters on that image frame for internal pipeline processing, the ISP 254 may freeze and require a hardware reset. As a result, instead of outputting an image frame with reduced quality, the image capture and processing system 200 may have to temporarily shut down and restart (e.g., the display screen may show a blank screen while the system 200 resets).

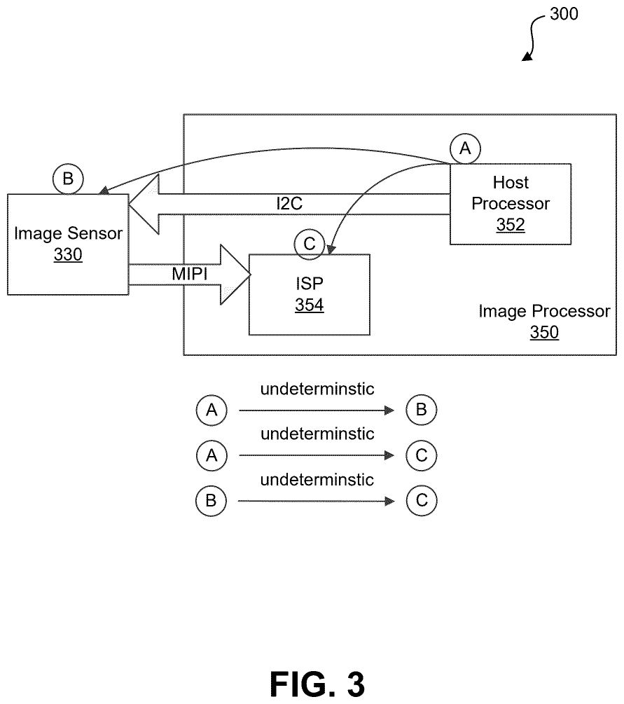

Synchronization between the image sensor 230 and the ISP 254 is important in order to provide an operational image capture system that generates high quality images without interruption and/or failure. FIG. 3 is a block diagram illustrating an example of an image capture and processing system 300 including an image processor 350 (including host processor 352 and ISP 354) in communication with an image sensor 330. The configuration shown in FIG. 3 is illustrative of traditional synchronization techniques used in camera systems. In general, the host processor 352 attempts to provide synchronization between the image sensor 330 and the ISP 354 using fixed periods of time by separately communicating with the image sensor 330 and the ISP 354. For example, in traditional camera systems, the host processor 352 communicates with the image sensor 330 (e.g., over an I2C port) and programs the image sensor 330 parameters with a first fixed period of time, such as 2-frame periods ahead of when that image frame will be processed by the ISP 354. The host processor 352 communicates with the ISP 354 (e.g., over an internal AHB bus or other interface) and programs the ISP 354 parameter settings with a second fixed period of time, such as 1-frame period ahead of when that image frame will be processed by the ISP 354.

The image sensor 330 can send image frames to the ISP 354 (B-to-C in FIG. 3), such as over an MIPI CSI-2 PHY port or interface, or other suitable interface. However, the communication between the host processor 352 and the image sensor 330 (shown as from A to B) is undeterministic. Similarly, the communication between the image sensor 330 and the ISP 354 (shown as from B to C) and the communication the host processor 352 and the ISP 354 (shown as from A to C) are also undeterministic. For example, there can be varying latencies in programming of the image sensor 330 and the ISP 354 by the host processor 352, which can result in a parameter settings mismatch between the sensor and the ISP. The latencies can be due to high CPU usage, congestion in one or more I/O ports, and/or due to other factors.

As previously mentioned, attackers may add perturbations (e.g., adversarial examples) in sensor data, such as image sensor data in the form of images. An attacker can perturb an image (e.g., digitally or via a physical patch and/or a projection attack) to create an object misclassification, misdetection, or hallucination, or to negatively affect trajectory planning.

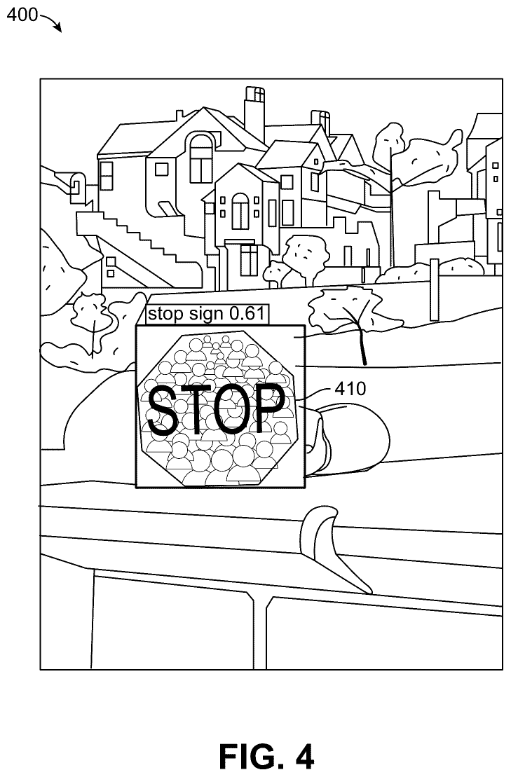

FIG. 4 is a diagram illustrating an example of an image 400 (e.g., image sensor data) including perturbations. In FIG. 4, the image 400 is shown to capture a scene of an environment including houses. In the image 400, pixels of the image have been perturbed (e.g., by an attacker) to include a false stop sign 410 in the scene.

Perturbations in the sensor data can cause inaccurate object detection by a perception system, which may be associated with a vehicle. The perturbations can be optimized, by an attacker, to fool the perception system and to be imperceptible to humans. Determination of perturbations in sensor data can be important to provide for an accurate object detection. Therefore, improved systems and techniques for detecting perturbations in sensor data can be useful.

In one or more aspects, the systems and techniques provide solutions for consistency-based perturbation detection for perception systems. In one or more examples, the systems and techniques allow for the detection of the existence of perturbations via a consistency technique. In some examples, the systems and techniques allow for the determination of the location of perturbed data (e.g., pixels) within sensor data (e.g., image sensor data, such as an image) to mitigate the effects of the perturbations. In one or more examples, the systems and techniques provide a means for measuring a consistency between output data of different vision tasks (e.g., perception models) using an overall numerical metric, for selecting the best perception models to employ to effectively detect perturbations in sensor data, for selecting thresholds (e.g., associated with a consistency score) for determining the existence of perturbations in sensor data, and for determining locations of regions (e.g., including pixels) of sensor data that include perturbations.

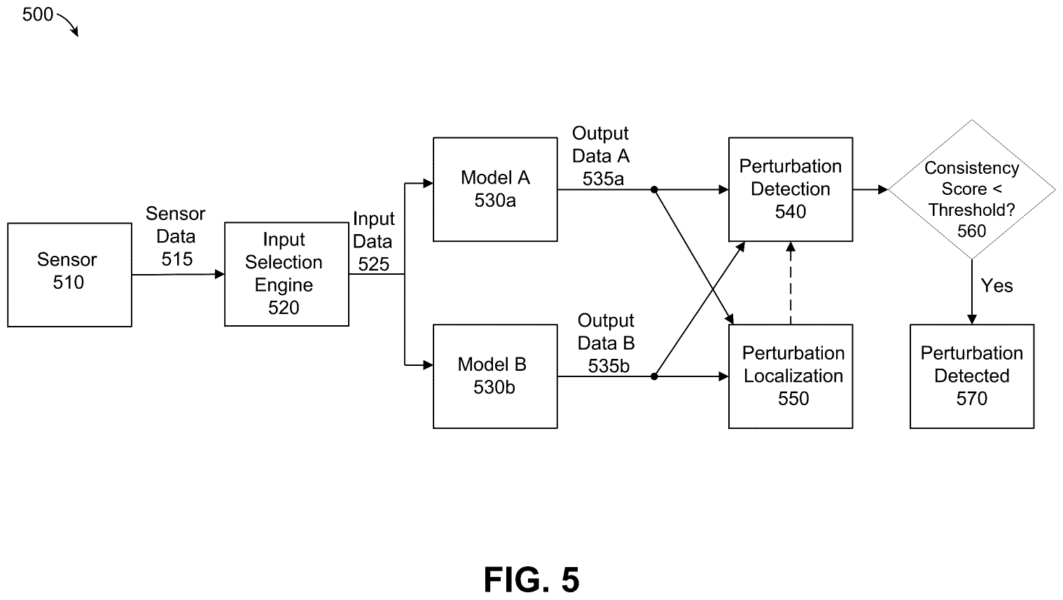

FIG. 5 shows an example of a process for detecting perturbations within sensor data. In particular, FIG. 5 is a diagram illustrating an example of a process 500 for consistency-based perturbation detection. In FIG. 5, during operation of the process 500, a sensor 510 may obtain sensor data 515. In one or more examples, the sensor 510 may be an image sensor, a radar sensor, or a Lidar sensor. The sensor data 515 may be image sensor data, radar sensor data, or Lidar sensor data. In one or more examples, the sensor 510 may be associated with a device, such as a computing device or a vehicle. In some examples, when the sensor 510 is in the form of an image sensor (e.g., a camera), the sensor 510 may obtain the sensor data 515, in the form of image sensor data (e.g., an image), by capturing a scene of an environment.

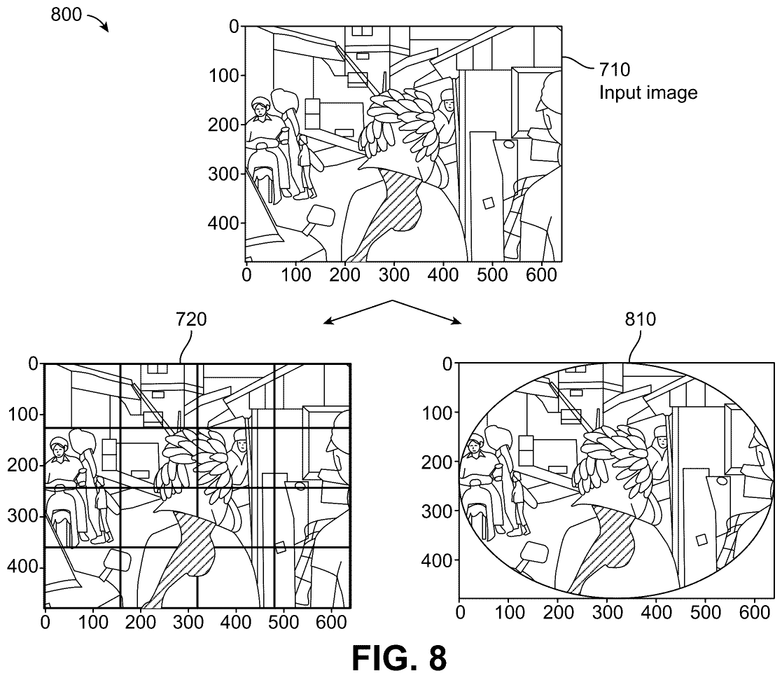

After the sensor data 515 has been obtained, one or more processors associated with the device may perform input selection (e.g., adaptive input selection) using an input selection engine 520 to select input data 525 from the sensor data 515, where the input data 525 is a portion of the sensor data 515. In one or more examples, the selecting of the input data 525 from the sensor data 515 is based on one or more objects being detected within the portion of the sensor data 515, a use case (e.g., autonomous driving use case) associated with the sensor data 515, a time of day the sensor data 515 was obtained, a day the sensor data 515 was obtained, a location associated with the sensor data 515, or a traffic scenario associated with the sensor data 515. The description of FIG. 8 describes in detail various different processes for selecting the input data 525.

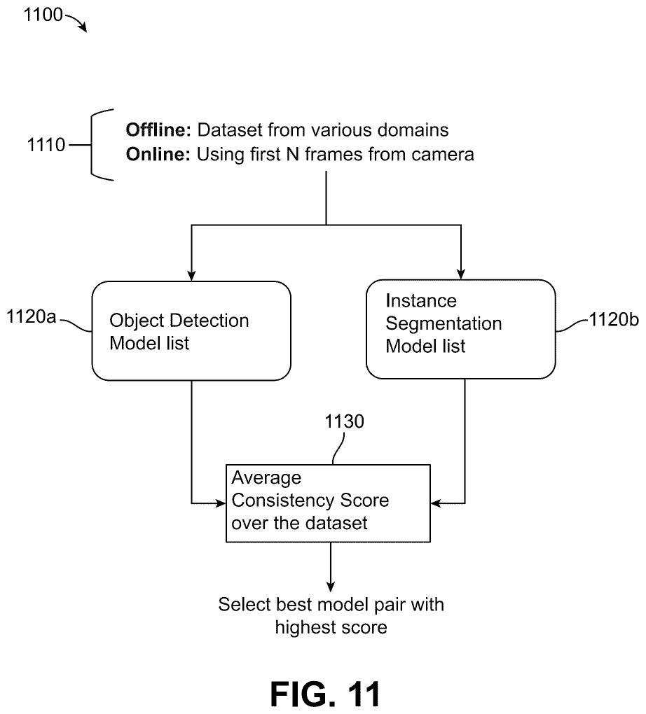

After the input data 525 has been selected, the one or more processors may choose an optimum pair of models (e.g., vision tasks), which have corresponding outputs. In one or more examples, the choosing of the pair of models (e.g., a first model, such as model A 530a, and a second model, such as model B 530b) may be based on determining a consistency score of outputs of the models using clean input data without perturbations, where the determined consistency score is greater than consistency scores of produced by other pairs of models based on the clean input data. The description of FIG. 11 describes in detail various different processes for choosing the optimum pair of models.

In one or more examples, the model A 530a and model b 530b may each be an object detection model, an instance segmentation model, a depth estimation model, or a traffic sign recognition model. In some examples, the object detection model may be a Faster R-CNN model, a you only look once (YOLO) model, a single-stage object detection (SSD) model, or a RetinaNet model. In one or more examples, the instance segmentation model may be a Mask R-CNN model, a Mask2Former model, a you only look once (YOLO) segmentation (Seg) model, or a successive approximation model (SAM).

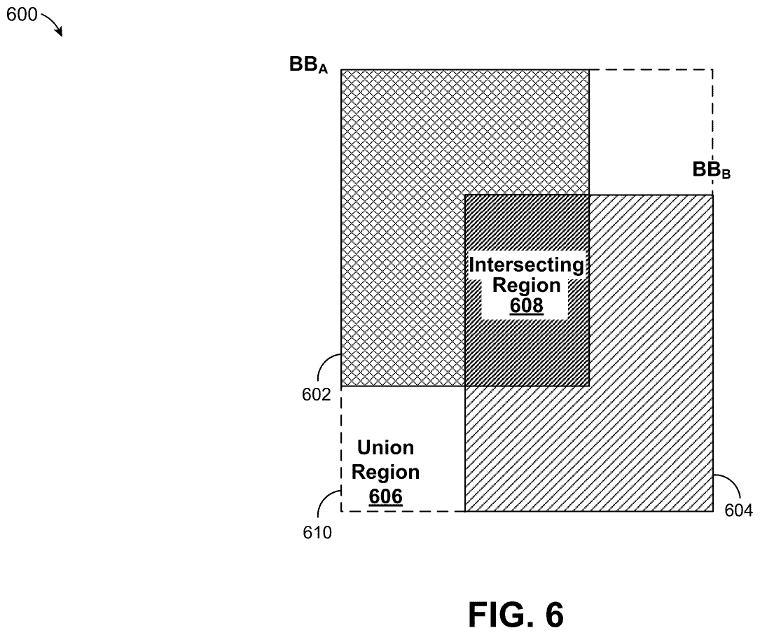

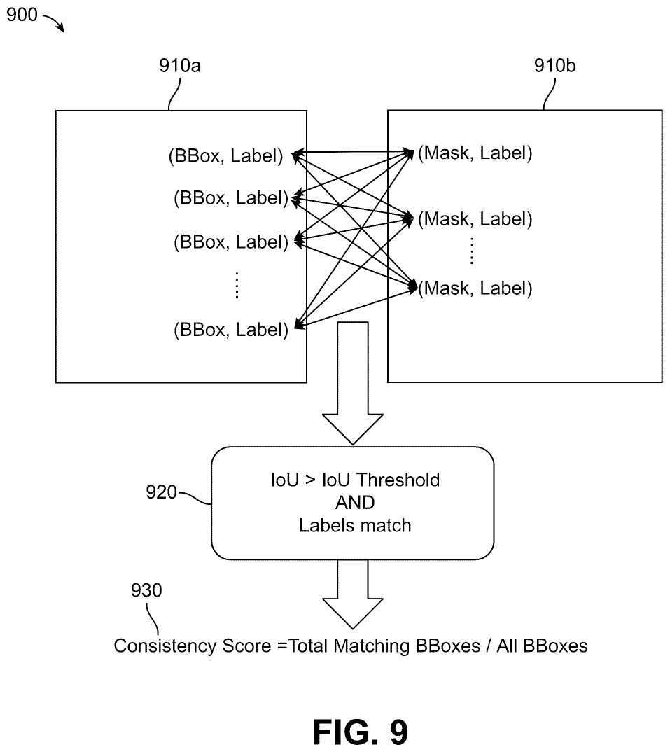

After the pair of models (e.g., model A 530a and model B 530b) has been chosen, the input data 525 may be inputted into the models. The model A 530a may then produce first output data (e.g., output data A 535a), based on input data 525. The model B 530b may produce second output data (e.g., output data B 535b) based on the input data 525. The one or more processors may then determine, during perturbation detection 540, based on the output data A 535a and the output data B 535b, a consistency score indicating a consistency between the output data A 535a and the output data B 535b. In one or more examples, determining the consistency score may be based on determining an intersection over union (IoU) of a pairwise comparison between the output data A 535a and the output data B 535b, and determining the IoU is greater than an IoU threshold value. The description of FIG. 6 describes in detail various different processes for determining IoU, and the description of FIG. 9 describes in detail various different processes for determining the consistency score.

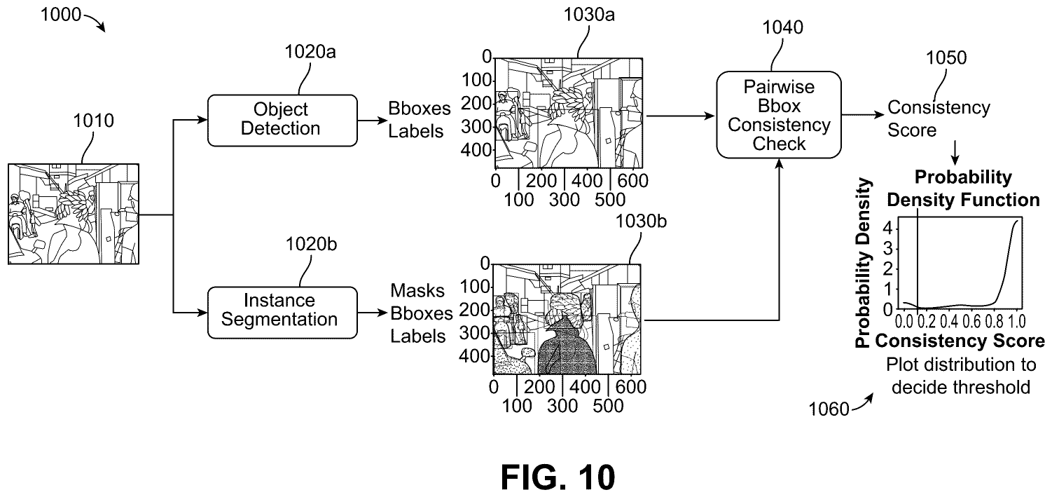

After the consistency score is determined, the one or more processors may determine, at block 560, whether the consistency score is less than a consistency score threshold. The description of FIG. 10 describes in detail various different processes for determining the consistency score threshold. The one or more processors, based on the consistency score being less than a consistency score threshold, can determine that the input data 525 includes one or more perturbations (e.g., a perturbation is detected at block 570).

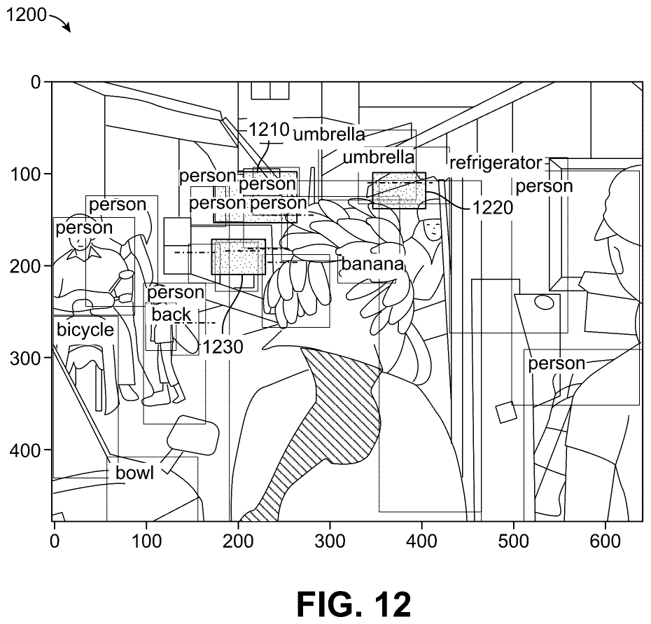

In one or more examples, the one or more processors may perform perturbation localization 550 by determining a region within the input data 525 for each perturbation of the one or more perturbations based on a density of bounding boxes, from the output data A 535a and/or the output data B 535b, located at the region. The description of FIG. 12 describes in detail various different processes for determining the locations of perturbations.

FIG. 6 is a diagram showing an example of an intersection I and union U of two bounding boxes, including bounding box BB_{A} 602 and bounding box BB_{B} 604. The intersecting region 608 includes the overlapped region between the bounding box BB_{A} 602 and the bounding box BB_{B} 604.

The union region 606 includes the union of bounding box BB_{A} 602 and bounding box BB_{B} 604. The union of bounding box BB_{A} 602 and bounding box BB_{B} 604 is defined to use the far corners of the two bounding boxes to create a new bounding box 610 (shown as dotted line). More specifically, by representing each bounding box with (x, y, w, h), where (x, y) is the upper-left coordinate of a bounding box, w and h are the width and height of the bounding box, respectively, the union of the bounding boxes would be represented as follows:

$$Union ( {BB}_{1} , {BB}_{2} ) = ( min ( {x}_{1} , {x}_{2} ) , min ( {y}_{1} , {y}_{2} ) , ( max ( {x}_{1} + {w}_{1} - 1 , {x}_{2} + {w}_{2} - 1 ) - min ( {x}_{1} , {x}_{2} ) ) , ( max ( {y}_{1} + {h}_{1} - 1 , {y}_{2} + {h}_{2} - 1 ) - min ( {y}_{1} , {y}_{2} ) ) )$$

Using FIG. 6. as an example, the first bounding box BB_{A} 602 and the second bounding box BB_{B} 604 can be determined to match if an overlapping area between the first bounding box BB_{A} 602 and the second bounding box BB_{B} 604 (the intersecting region 608) divided by the union 610 of the bounding boxes BB_{A} 602 and BB_{B} 604 is greater than an IOU threshold (denoted as

$${T}_{IOU} < \frac{Area of Intersecting Region 308}{Area of Union 310} ) .$$

The IOU threshold can be set to any suitable amount, such as 50%, 60%, 70%, 75%, 80%, 90%, or other configurable amount. In one illustrative example, the first bounding box BB_{A} 602 and the second bounding box BB_{B} 604 can be determined to be a match when the IOU for the bounding boxes is at least 70%.

In another example, an overlapping area technique can be used to determine a match between bounding boxes. For instance, the first bounding box BB_{A} 602 and the second bounding box BB_{B} 604 can be determined to be a match if an area of the first bounding box BB_{A} 602 and/or an area the second bounding box BB_{B} 604 that is within the intersecting region 608 is greater than an overlapping threshold. The overlapping threshold can be set to any suitable amount, such as 50%, 60%, 70%, or other configurable amount. In one illustrative example, the first bounding box BB_{A} 602 and the second bounding box BB_{B} 604 can be determined to be a match when at least 65% of the first bounding box BB_{A} 602 or the second bounding box BB_{B} 604 is within the intersecting region 608.

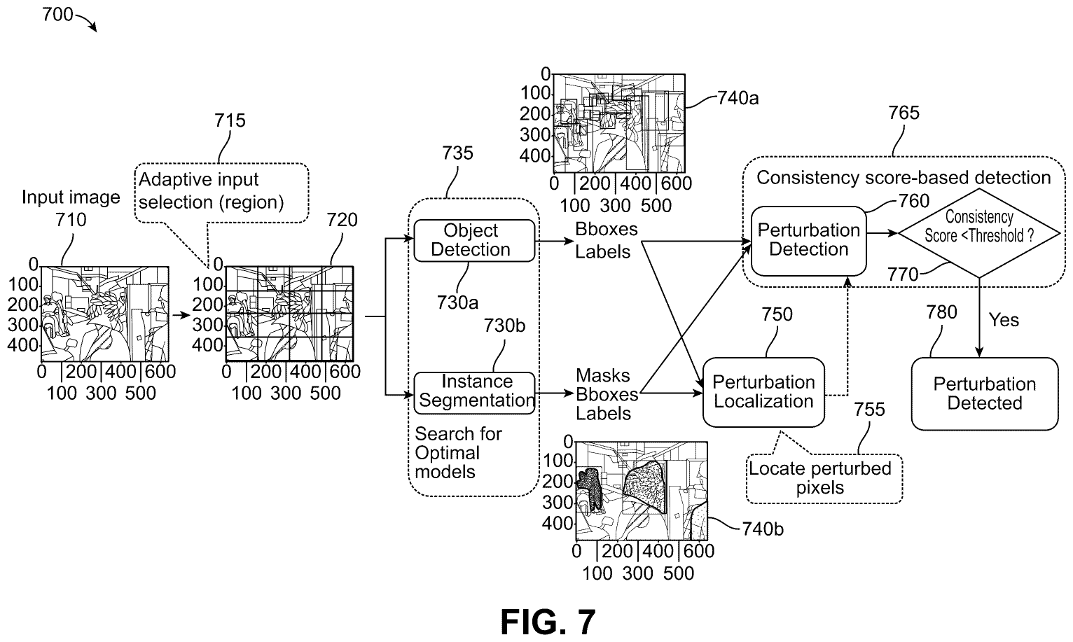

FIG. 7 shows an example of a process, employing an object detection model and an instance segmentation model, for detecting perturbations within sensor data. In particular, FIG. 7 is a diagram illustrating an example of a process 700 for consistency-based perturbation detection, where the system employs an object detection model and an instance segmentation model. In FIG. 7, during operation of the process 700, a sensor, associated with a device (e.g., a computing device or a vehicle), may obtain sensor data in the form of an input image 710. In one or more examples, the sensor may obtain the input image 710 by capturing a scene of an environment.

After the sensor data (e.g., input image 710) has been obtained, one or more processors associated with the device may perform adaptive input selection 715 to select input data from the input image 710, where the input data is a portion of the input image 710. To select the input data, the one or more processors may partition (divide) the input image 710 into a grid (e.g., as shown in grided image 720). In one or more examples, the selected input data may be based on one or more objects detected within the portion of the input image 710. For example, one or more objects may have been detected within the four by four matrix of cells located at the center of the grided image 720. As such, the selected input data may include the four by four matrix of cells located at the center of the grided image 720.

After the input data has been selected, the one or more processors may choose (e.g., search for) an optimal pair of models 735 with corresponding outputs. In FIG. 7, the chosen pair of models is shown to include an object detection model 730a and a segmentation model 730b. After the pair of models has been chosen, the input data may be inputted into the models. The objection detection model 730a may then produce first output data 740a based on the input data. The first output data 740a may include the input data with bounding boxes (BBoxes) and labels. The instance segmentation model 730b may produce second output data 740b based on the input data 525. The second output data 740b may include the input data with masks, bounding boxes, and labels.

The one or more processors may then determine, during perturbation detection 760 of consistency score-based detection 765, based on the first output data 740a and the second output data 740b, a consistency score indicating a consistency between the first output data 740a and the second output data 740b. In one or more examples, determining the consistency score may be based on determining an intersection over union (IoU) of a pairwise comparison between the first output data 740a and the second output data 740b, and determining the IoU is greater than an IoU threshold value.

After the consistency score is determined, the one or more processors may determine whether the consistency score is less than a consistency score threshold 770. The one or more processors, based on the consistency score being less than a consistency score threshold, can determine that the input data includes one or more perturbations (e.g., a perturbation is detected 780).

In one or more examples, the one or more processors may perform perturbation localization 750 to locate perturbed pixels 755 by determining a region within the input data for each perturbation of the one or more perturbations based on a density of bounding boxes, from the first output data 740a and the second output data 740b, located at the region.

FIG. 8 shows various different processes for selecting the input data (e.g., input data 525 of FIG. 5). In particular, FIG. 8 is a diagram illustrating different examples 800 of input data. In FIG. 8, sensor data (e.g., input image 710 of FIG. 7) is shown. For selecting input data, regions of interest of the sensor data (e.g., input image 710) may be selected for the detection of perturbations. Less important areas (or regions, such as corners) within the sensor data (e.g., input image 710) may be adaptively masked out.

In one or more examples, for selecting the input data, one or more processors (e.g., associated with a device, such as a computing device or a vehicle) can divide the sensor data (e.g., input image 710) into a grid including a plurality of grid cells. For example, the input image 710 may be divided into four by four grids (e.g., as shown in the gridded image 720). When the selection process starts, the one or more processors can monitor the sensor data (e.g., input images, including the input image 710) for an initial period of time (e.g., the first sixty seconds), and can record the grid cells within the input images that have objects detected. The one or more processors can select the input data to include only the grid cells that have one or more objects detected within the grid cells. The one or more processors will only focus of those grid cells for calculating the consistency score.

In some examples, for selecting the input data, one or more processors (e.g., associated with a device, such as a computing device or a vehicle) can determine the largest oval (or circular) area within the sensor data (e.g., input image 710). The one or more processors can select the input data to include only the scene within the largest oval (or circular area), as shown in input image 810, which shows the scene located outside of the largest oval blocked (masked) out. The one or more processors will only look at the objects detected within the oval (or circular) area for calculating the consistency score.

In one or more examples, the adaptive selection of input data (e.g., input data 525 of FIG. 5) provides the benefits of improving the efficiency of object detection by only focusing on a certain portion of the sensor data and improving the accuracy of the perturbation detection by neglecting noises and perturbation in less important areas of the sensor data.

FIG. 9 shows an example process for determining a consistency score. In particular, FIG. 9 is a diagram illustrating an example of a process 900 for determining a consistency score 930 between two sets of output data. For determining a consistency score 930, one or more processors (e.g., associated with a device, such as a computing device or a vehicle) can measure the outputs (e.g., output data A 910a and output data B 910b) of two models (e.g., vision tasks), which may include an object detection model and a segmentation model. In FIG. 9, the output data A 910a, which is output from an object detection model, is shown to include a plurality of bounding boxes with associated labels. The output data B 910b, which is output from an instance segmentation model, is shown to include a plurality of masks with associated labels.

The one or more processors can perform a pairwise comparison of the output data A 910a with the output data B 910b to calculate an IoU for the bounding boxes of the output data A 910a and the masks of the output data B 910b. The description of FIG. 6 describes methods for calculating the IoU. The one or more processors can then determine (at block 920) whether the calculated IoU for one or more of the pairs of data is greater than an IoU threshold (e.g., an IoU threshold with a value of 0.5 or other IoU threshold value). For the pairs of data with an IoU greater than the IoU threshold, the one or more processors can also determine (at block 920) whether the labels of the output data A 910a match the labels of the output data B 910b. For the pairs of data with an IoU greater than the IoU threshold and with matching labels, the one or more processors can calculate the number of those matching pairs (e.g., which have matching bounding boxes). The one or more processors may then calculate a consistency score 930 based on the total number of bounding boxes of the output data A 910a divided by the calculated number of matching pairs.

An example of pseudocode for determining the consistency score 930 is as follows:

```
for bbox in detected_bboxes:
  # ignore all small bboxes
  if area(bbox) < SMALL:
    continue
  # Check if there is a matching mask for the bbox
  for mask in segmenation_masks:
    iou[bbox, mask] = IoU(bbox, mask)
    if iou[bbox, mask] > 0.5 and bbox_label ==mask_label:
      bbox_match[bbox]=True
    continue
consistency_score = sum(bbox_match==True)/len(bbox_match)
```

FIG. 10 shows example processes for determining a consistency score threshold. In particular, FIG. 10 is a diagram illustrating an example of a process 1000 for determining a consistency score threshold.

In one or more examples, for determining a consistency score threshold during offline operation (e.g., prior to deployment of a device), input data (e.g., including input data 1010) may be selected (e.g., by one or more processors) to include clean input data without any perturbations. In some examples, the clean input data may include a clean dataset, such as Microsoft (MS) common objects in context (COCO) data or diverse driving data set BDD 100K, which is free of any perturbations.

In some examples, for determining a consistency score threshold during online operation (e.g., during deployment of a device), input data (e.g., including input data 1010) may be selected (e.g., by the one or more processors) to include X number of sensor data with a low likelihood of having perturbations.

For determining the consistency score threshold during offline or online operation, the selected input data (e.g., in the form of a dataset of images) may be inputted (e.g., one by one) into two models, which may include an object detection model 1020a and an instance segmentation model 1020b. The first model (e.g., object detection model 1020a) may produce first output data 1030a based on the input data (e.g., input data 1010). The first output data 1030a may include the input data with bounding boxes and labels. The second model (e.g., instance segmentation model 1020b) may produce second output data 1030b based on the input data (e.g., input data 1010). The second output data 1030b may include the input data with masks, bounding boxes, and labels.

The one or more processors (e.g., associated with a device, such as a computing device or a vehicle) may then determine, during a pairwise bounding box consistency check 1040, based on the first output data 1030a and the second output data 1030b, a consistency score 1050 indicating a consistency between the first output data 1030a and the second output data 1030b. In one or more examples, determining the consistency score 1050 may be based on determining an intersection over union (IoU) of a pairwise comparison between the first output data 1030a and the second output data 1030b, and determining the IoU is greater than an IoU threshold value. The process of determining all of the consistency scores 1050 for the entire data set of the input data can be performed by the one or more processors.

After the consistency scores 1050 for the entire data set of the input data are determined, the one or more processors may plot a graph with a distribution of the determined consistency scores 1050 of the entire data set of the input data. Graph 1060 shows an example of a distribution of the determined consistency scores 1050, where the x-axis denotes the consistency score and the y-axis denotes the probability density. The one or more processors can select the consistency score threshold, based on a requirement of a false positive rate (e.g., a rate of five percent) of the perturbation detection according to the distribution.

FIG. 11 shows example processes for selecting a pair of models, which will yield a high consistency between clean sensor data (e.g., clean images) without perturbations, to reduce false positives for the perturbation detection of the processes 500 and 700 of FIGS. 5 and 7, respectively. In particular, FIG. 11 is a diagram illustrating an example of a process 1100 for selecting a pair of models to employ for consistency-based perturbation detection.

In one or more examples, for selecting a pair of models during offline operation (e.g., prior to deployment of a device), input data 1110 may be selected (e.g., by one or more processors) to include clean input data without any perturbations. In some examples, the clean input data may include a clean dataset from various different domains (e.g., MS COCO data or diverse driving data set BDD 100K) that is free of any perturbations.

In some examples, for determining a pair of models during online operation (e.g., during deployment of a device), the input data 1110 including N number of sensor data (e.g., N number of images) may be obtained by the one or more sensors. In some examples, the number N may be adaptively configured (e.g., by one or more processors) based on a sensor data (e.g., image frames) per second and a time window for collection of the sensor data.

For selecting a pair of models during offline or online operation, one or more processors (e.g., associated with a device, such as a computing device or a vehicle) may collect a set of models for object detection (e.g., included within an object detection model list 1120a) and a set of models for instance segmentation (e.g., included within an instance segmentation model list 1120b). The one or more processors may then iteratively run a consistency check on (e.g., determine a consistency score for) each model pair (e.g., including one object detection model and one instance segmentation model) from the sets of models using the input data 1110. The one or more processors may then calculate an average consistency score over the dataset 1130 (e.g., over all of the input data 1110, such as over all of the images). The one or more processors may select the model pair with the highest average consistency score.

In one or more aspects, adversarial examples may be similarly effective on tasks (e.g., models) that use the same backbone. In one or more examples, heterogeneous network architecture may be used for the models (e.g., vision tasks) that are employed for the detection. This assumes that AE can only work for one of the models. In some aspects, data sets of different domains (e.g., including street view images, such as from the BDD100k dataset or the MS COCO dataset) may impact the selection of the models. None of the models may be universal for all domains and, as such, the best models need to be selected taking the domain under consideration.

FIG. 12 shows an example for determining locations of perturbations in sensor data. In particular, FIG. 12 is a diagram illustrating an example 1200 of determining regions of perturbations within input data based on densities of bounding boxes. In one or more examples, for determining locations of perturbations in sensor data, one or more processors (e.g., associated with a device, such as a computing device or a vehicle) can determine a region (e.g., pixels) within the input data has perturbations based on a density of false bounding boxes located at the region (e.g., the pixels). In FIG. 12, regions 1210, 1220, 1230 within input data are shown to have high densities of bounding boxes and, as such, it can be assumed that most of these bounding boxes are false because it is not likely for a region (e.g., a pixel) to be associated with more than two bounding boxes. As such, the pixels within these regions 1210, 1220, 1230 can be determined (e.g., by one or more processors) to be perturbed.

An example of pseudocode for determining whether a pixel in input data (e.g., an image) is perturbed is as follows:

```
for bbox in detected_bboxes:
  if pixel in bbox:
    box_count[pixel]++1
if box_count[pixel] > MAX_COUNT:
  perturbed[pixel] = True
```

In one or more examples, MAX_COUNT is a threshold that may be determined by calculating the maximum density of bounding boxes within a clean dataset of images.

In one or more aspects, after perturbations have been located within sensor data, one or more processors may take various different actions. In one or more examples, the one or more processors may mask the perturbed pixels within the sensor data and not use the masked pixels for the perception tasks (e.g., the models). In some examples, the one or more processors may fix (e.g., remove) the perturbations by applying denoising techniques to the sensor data. In one or more examples, the one or more processors may refine the calculation of the consistency score metric by ignoring the detection output in the perturbed area. In some examples, the one or more processors may identify a pattern of the attack (e.g., including an attack type, attacker objectives, and/or attack strength).

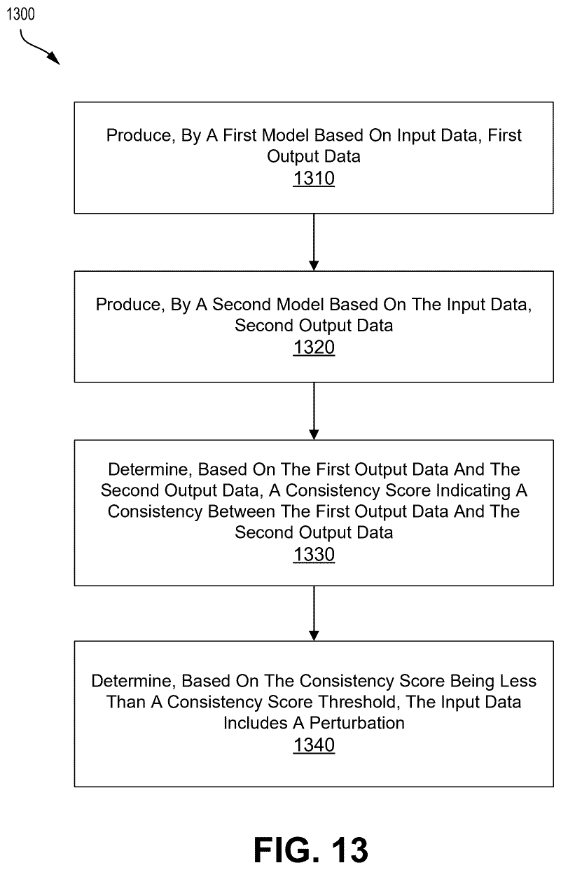

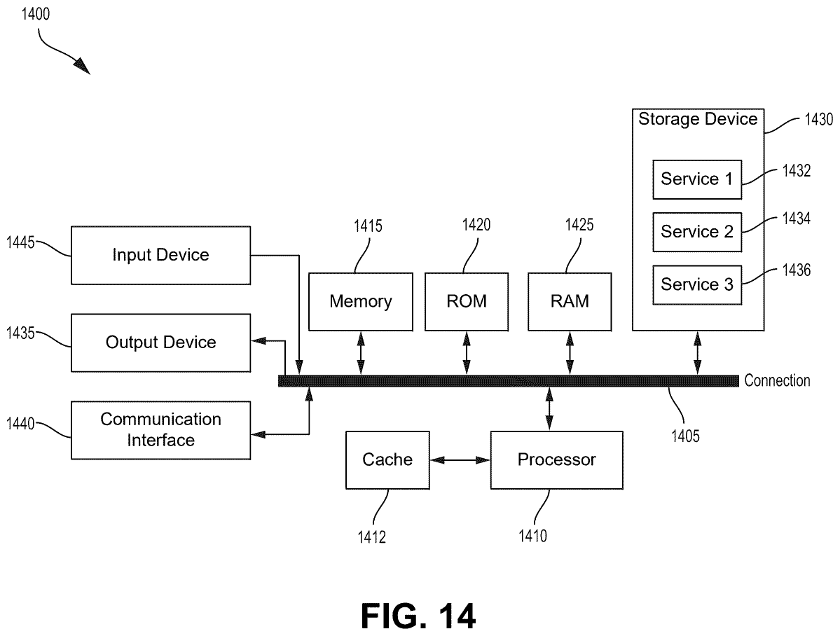

FIG. 13 is a flow chart illustrating an example of a process 1300 for perturbation detection. The process 1300 can be performed by a computing device (e.g., a computing device or computing system 1400 of FIG. 14) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1410 of FIG. 14, or other processor(s)). Further, the transmission and reception of signals by the computing device in the process 1300 may be enabled, for example, by one or more antennas and/or one or more transceivers (e.g., wireless transceiver(s)).

At block 1310, the computing device (or component thereof) can produce, using a first model based on input data (e.g., using model A 530a based on input data 525 of FIG. 5), first output data (e.g., output data A 535a of FIG. 5). In some aspects, the input data includes image sensor data, radar sensor data, light detection and ranging (Lidar) sensor data, any combination thereof, and/or other data. At block 1320, the computing device (or component thereof) can produce, using a second model based on the input data (e.g., using model B 530b based on the input data 525 of FIG. 5), second output data (e.g., output data B 535b of FIG. 5). In some aspects, the computing device (or component thereof) can select the input data from sensor data (e.g., using input selection engine 520). In such aspects, the input data can include a region of interest of the sensor data selected based on an object detected within the region of interest of the sensor data, a use case associated with the sensor data, a time of day the sensor data was obtained, a day the sensor data was obtained, a location associated with the sensor data, a traffic scenario associated with the sensor data, any combination thereof, and/or based on other information or factors. In some aspects, the computing device (or component thereof) can determine a region within the input data for the perturbation based on a density of bounding boxes, from at least one of the first output data or the second output data, located at the region.

At block 1330, the computing device (or component thereof) can determine, based on the first output data and the second output data, a consistency score indicating a consistency between the first output data and the second output data. In some aspects, to determine the consistency score, the computing device (or component thereof) can determine an intersection over union (IoU) of a pairwise comparison between the first output data and the second output data and can compare the IoU to an IoU threshold value (e.g., as discussed with at least FIG. 6 and FIG. 10).

At block 1340, the computing device (or component thereof) can determine, based on the consistency score being less than a consistency score threshold, the input data comprises a perturbation. For instance, referring to FIG. 5 as an illustrative example, a perturbation is detected at block 570 based on the consistency score being less than the consistency score threshold at block 560.

In some aspects, the computing device (or component thereof) can produce, using the first model based on input data without perturbations, third output data and can produce, using a second model based on the input data without perturbations, fourth output data. The computing device (or component thereof) can determine, based on the first output data and the second output data, an additional consistency score indicating a consistency between the third output data and the fourth output data. The additional consistency score is greater than consistency scores produced by other pairs of models based on the input data without perturbations. The computing device (or component thereof) can select the first model and the second model to use as a pair of models based on the additional consistency score being greater than consistency scores produced by the other pairs of models based on the input data without perturbations (e.g., as discussed with respect to at least FIG. 11).

In some aspects, the first model is a first type of model and the second model is a second type of model, wherein the second type of model is different from the first type of model, and wherein the first model and the second model. For instance, the first type of model can be an object detection model, an instance segmentation model, a depth estimation model, or a traffic sign recognition model, and the second type of model can be a different one of the object detection model, the instance segmentation model, the depth estimation model, or the traffic sign recognition model. In some cases, the techniques described herein relate to an apparatus, wherein the object detection model is a Faster R-CNN model, a you only look once (YOLO) model, a single-stage object detection (SSD) model, or a RetinaNet model. In some cases, the instance segmentation model is a Mask R-CNN model, a Mask2Former model, a YOLO seg model, or a successive approximation model (SAM).

In some cases, the computing device of process 1300 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1300 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a block diagram illustrating an example of a computing system 1400, which may be employed for consistency-based perturbation detection for perception systems. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LiDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for perturbation detection, the apparatus comprising: at least one memory; and at least one processor coupled to the at least one memory and configured to: produce, using a first model based on input data, first output data; produce, using a second model based on the input data, second output data; determine, based on the first output data and the second output data, a consistency score indicating a consistency between the first output data and the second output data; and determine, based on the consistency score being less than a consistency score threshold, the input data comprises a perturbation.

Aspect 2. The apparatus of Aspect 1, wherein the at least one processor is configured to select the input data from sensor data, wherein the input data comprises a region of interest of the sensor data selected based on at least one of an object detected within the region of interest of the sensor data, a use case associated with the sensor data, a time of day the sensor data was obtained, a day the sensor data was obtained, a location associated with the sensor data, or a traffic scenario associated with the sensor data.

Aspect 3. The apparatus of any of Aspects 1 or 2, wherein the input data comprises image sensor data, radar sensor data, or light detection and ranging (Lidar) sensor data.

Aspect 4. The apparatus of any of Aspects 1 to 3, wherein, to determine the consistency score, the at least one processor is configured to: determine an intersection over union (IoU) of a pairwise comparison between the first output data and the second output data; and compare the IoU to an IoU threshold value.

Aspect 5. The apparatus of any of Aspects 1 to 4, wherein the at least one processor is configured to determine a region within the input data for the perturbation based on a density of bounding boxes, from at least one of the first output data or the second output data, located at the region.

Aspect 6. The apparatus of any of Aspects 1 to 5, wherein the at least one processor is configured to: produce, using the first model based on input data without perturbations, third output data; produce, using a second model based on the input data without perturbations, fourth output data; determine, based on the first output data and the second output data, an additional consistency score indicating a consistency between the third output data and the fourth output data, wherein the additional consistency score is greater than consistency scores produced by other pairs of models based on the input data without perturbations; and select the first model and the second model to use as a pair of models based on the additional consistency score being greater than consistency scores produced by the other pairs of models based on the input data without perturbations.

Aspect 7. The apparatus of any of Aspects 1 to 6, wherein the first model is a first type of model and the second model is a second type of model, wherein the second type of model is different from the first type of model, and wherein the first model and the second model.

Aspect 8. The apparatus of Aspect 7, wherein the first model is an object detection model, an instance segmentation model, a depth estimation model, or a traffic sign recognition model, and wherein the second model is a different one of the object detection model, the instance segmentation model, the depth estimation model, or the traffic sign recognition model.

Aspect 9. The apparatus of Aspect 8, wherein the object detection model is a Faster R-CNN model, a you only look once (YOLO) model, a single-stage object detection (SSD) model, or a RetinaNet model.

Aspect 10. The apparatus of any of Aspects 8 or 9, wherein the instance segmentation model is a Mask R-CNN model, a Mask2Former model, a you only look once (YOLO) segmentation (Seg) model, or a successive approximation model (SAM).

Aspect 11. A method for perturbation detection at a device, the method comprising: producing, by a first model based on input data, first output data; producing, by a second model based on the input data, second output data; determining, based on the first output data and the second output data, a consistency score indicating a consistency between the first output data and the second output data; and determining, based on the consistency score being less than a consistency score threshold, the input data comprises a perturbation.

Aspect 12. The method of Aspect 11, further comprising selecting the input data from sensor data, wherein the input data comprises a region of interest of the sensor data selected based on at least one of an object detected within the region of interest of the sensor data, a use case associated with the sensor data, a time of day the sensor data was obtained, a day the sensor data was obtained, a location associated with the sensor data, or a traffic scenario associated with the sensor data.

Aspect 13. The method of any of Aspects 11 or 12, wherein the input data comprises image sensor data, radar sensor data, or light detection and ranging (Lidar) sensor data.

Aspect 14. The method of any of Aspects 11 to 13, wherein determining the consistency score is based on: determining an intersection over union (IoU) of a pairwise comparison between the first output data and the second output data; and comparing the IoU to an IoU threshold value.

Aspect 15. The method of any of Aspects 11 to 14, further comprising determining a region within the input data for the perturbation based on a density of bounding boxes, from at least one of the first output data or the second output data, located at the region.

Aspect 16. The method of any of Aspects 11 to 15, further comprising: producing, by the first model based on input data without perturbations, third output data; producing, by a second model based on the input data without perturbations, fourth output data; determining, based on the first output data and the second output data, an additional consistency score indicating a consistency between the third output data and the fourth output data, wherein the additional consistency score is greater than consistency scores produced by other pairs of models based on the input data without perturbations; and selecting the first model and the second model to use as a pair of models based on the additional consistency score being greater than consistency scores produced by the other pairs of models based on the input data without perturbations.

Aspect 17. The method of any of Aspects 11 to 16, wherein the first model is a first type of model and the second model is a second type of model, wherein the second type of model is different from the first type of model, and wherein the first model and the second model.

Aspect 18. The method of Aspect 17, wherein the first model is an object detection model, an instance segmentation model, a depth estimation model, or a traffic sign recognition model, and wherein the second model is a different one of the object detection model, the instance segmentation model, the depth estimation model, or the traffic sign recognition model.

Aspect 19. The method of Aspect 18, wherein the object detection model is a Faster R-CNN model, a you only look once (YOLO) model, a single-stage object detection (SSD) model, or a RetinaNet model.

Aspect 20. The method of any of Aspects 18 or 19, wherein the instance segmentation model is a Mask R-CNN model, a Mask2Former model, a you only look once (YOLO) segmentation (Seg) model, or a successive approximation model (SAM).

Aspect 21. A non-transitory computer-readable medium having stored thereon instructions that, when executed by at least one processor, cause the at least one processor to perform operations according to any of Aspects 11 to 20.

Aspect 22. An apparatus for perturbation detection, the apparatus including one or more means for performing operations according to any of Aspects 11 to 20.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for perturbation detection, the apparatus comprising:
at least one memory; and
at least one processor coupled to the at least one memory and configured to:
produce, using a first model based on input data, first output data;
produce, using a second model based on the input data, second output data;
determine, based on the first output data and the second output data, a consistency score indicating a consistency between the first output data and the second output data; and
determine, based on the consistency score being less than a consistency score threshold, the input data comprises a perturbation.

2. The apparatus of claim 1, wherein the at least one processor is configured to select the input data from sensor data, wherein the input data comprises a region of interest of the sensor data selected based on at least one of an object detected within the region of interest of the sensor data, a use case associated with the sensor data, a time of day the sensor data was obtained, a day the sensor data was obtained, a location associated with the sensor data, or a traffic scenario associated with the sensor data.

3. The apparatus of claim 1, wherein the input data comprises image sensor data, radar sensor data, or light detection and ranging (Lidar) sensor data.

4. The apparatus of claim 1, wherein, to determine the consistency score, the at least one processor is configured to:
determine an intersection over union (IoU) of a pairwise comparison between the first output data and the second output data; and
compare the IoU to an IoU threshold value.

5. The apparatus of claim 1, wherein the at least one processor is configured to determine a region within the input data for the perturbation based on a density of bounding boxes, from at least one of the first output data or the second output data, located at the region.

6. The apparatus of claim 1, wherein the at least one processor is configured to:
produce, using the first model based on input data without perturbations, third output data;
produce, using a second model based on the input data without perturbations, fourth output data;
determine, based on the first output data and the second output data, an additional consistency score indicating a consistency between the third output data and the fourth output data, wherein the additional consistency score is greater than consistency scores produced by other pairs of models based on the input data without perturbations; and
select the first model and the second model to use as a pair of models based on the additional consistency score being greater than consistency scores produced by the other pairs of models based on the input data without perturbations.

7. The apparatus of claim 1, wherein the first model is a first type of model and the second model is a second type of model, wherein the second type of model is different from the first type of model, and wherein the first model and the second model.

8. The apparatus of claim 7, wherein the first model is an object detection model, an instance segmentation model, a depth estimation model, or a traffic sign recognition model, and wherein the second model is a different one of the object detection model, the instance segmentation model, the depth estimation model, or the traffic sign recognition model.

9. The apparatus of claim 8, wherein the object detection model is a Faster R-CNN model, a you only look once (YOLO) model, a single-stage object detection (SSD) model, or a RetinaNet model.

10. The apparatus of claim 8, wherein the instance segmentation model is a Mask R-CNN model, a Mask2Former model, a you only look once (YOLO) segmentation (Seg) model, or a successive approximation model (SAM).

11. A method for perturbation detection at a device, the method comprising:
producing, by a first model based on input data, first output data;
producing, by a second model based on the input data, second output data;
determining, based on the first output data and the second output data, a consistency score indicating a consistency between the first output data and the second output data; and
determining, based on the consistency score being less than a consistency score threshold, the input data comprises a perturbation.

12. The method of claim 11, further comprising selecting the input data from sensor data, wherein the input data comprises a region of interest of the sensor data selected based on at least one of an object detected within the region of interest of the sensor data, a use case associated with the sensor data, a time of day the sensor data was obtained, a day the sensor data was obtained, a location associated with the sensor data, or a traffic scenario associated with the sensor data.

13. The method of claim 11, wherein the input data comprises image sensor data, radar sensor data, or light detection and ranging (Lidar) sensor data.

14. The method of claim 11, wherein determining the consistency score is based on:
determining an intersection over union (IoU) of a pairwise comparison between the first output data and the second output data; and
comparing the IoU to an IoU threshold value.

15. The method of claim 11, further comprising determining a region within the input data for the perturbation based on a density of bounding boxes, from at least one of the first output data or the second output data, located at the region.

16. The method of claim 11, further comprising:
producing, by the first model based on input data without perturbations, third output data;
producing, by a second model based on the input data without perturbations, fourth output data;
determining, based on the first output data and the second output data, an additional consistency score indicating a consistency between the third output data and the fourth output data, wherein the additional consistency score is greater than consistency scores produced by other pairs of models based on the input data without perturbations; and
selecting the first model and the second model to use as a pair of models based on the additional consistency score being greater than consistency scores produced by the other pairs of models based on the input data without perturbations.

17. The method of claim 11, wherein the first model is a first type of model and the second model is a second type of model, wherein the second type of model is different from the first type of model, and wherein the first model and the second model.

18. The method of claim 17, wherein the first model is an object detection model, an instance segmentation model, a depth estimation model, or a traffic sign recognition model, and wherein the second model is a different one of the object detection model, the instance segmentation model, the depth estimation model, or the traffic sign recognition model.

19. The method of claim 18, wherein the object detection model is a Faster R-CNN model, a you only look once (YOLO) model, a single-stage object detection (SSD) model, or a RetinaNet model.

20. The method of claim 18, wherein the instance segmentation model is a Mask R-CNN model, a Mask2Former model, a you only look once (YOLO) segmentation (Seg) model, or a successive approximation model (SAM).
